(19) United States
(12) Patent Application Publication
(10) Pub. No.: US 2006/0005777 A1
(43) Pub. Date: Jan. 12, 2006

(54) Wheeled litter box

(76) Inventors: Anabella V. Galindo, Calexico, CA (US); Ana I. Gutierrez, Calexico, CA (US)

Correspondence Address: LITMAN LAW OFFICES, LTD, PO BOX 15035, CRYSTAL CITY STATION, ARLINGTON, VA, 22215, US

(21) Appl. No.: 11/155,547

(22) Filed: Jun. 20, 2005

Related U.S. Application Data
(60) Provisional application No. 60/585,758, filed on Jul. 6, 2004.

(51) Int. Cl. A01K 1/035

(52) U.S. Cl. 119/165

(57) ABSTRACT

A wheeled housing having separable top and bottom components. A covered opening is formed in the housing to provide for easy entrance and exit by a pet. The housing has an air filter positioned on the top component. An extendable handle is affixed to the top adjacent the filter. Brakes are provided for the rear wheels to prevent the housing from being pushed by the pet.

### CROSS-REFERENCE TO RELATED APPLICATION

This application claims the benefit of U.S. Provisional Patent Application Ser. No. 60/585,758, filed Jul. 6, 2004.

### BACKGROUND OF THE INVENTION

1. Field of the Invention

The present invention generally relates to pet accessories. More specifically, the present invention is drawn to a portable litter box.

2. Description of the Related Art

If the family pet is a cat, a small dog, a ferret, etc., a litter box is normally required wherein the pet may deposit urine and excrement. Usually the litter box takes the form of a tray having granular absorbent material therein, which tray must be emptied and the granular material replaced on a regular basis. Ideally, the granular material would function to contain the wastes and the odors produced thereby. Unfortunately, this is not always the case. Most of the time, the pet is prone to cover the waste and will scatter the granular material beyond the confines of the tray to the floor or carpet. Furthermore, the granular materials are not always effective in absorbing the odors of both urine and excrement. This scenario presents an ongoing problem for the pet owner in that the floor and/or carpet must be cleaned to rid the same of the obnoxious odors. The art would certainly welcome a litter container that would alleviate the shortcomings of the above-described litter tray.

There are many portable and confined litter containers known in the related art. Samples of such containers are identified and cited in the accompanying IDS. However, none of the identified and cited inventions and patents, taken either singly or in combination, is seen to disclose a unique litter container as will subsequently be described and claimed in the instant invention.

### SUMMARY OF THE INVENTION

The present invention is a wheeled housing having separable top and bottom components. A covered opening is formed in the housing to provide for easy entrance and exit by a pet. The housing has an air filter positioned on the top component. An extendable handle is affixed to the top adjacent the filter. Brakes are provided for the rear wheels to prevent the housing from being pushed by the pet.

Accordingly, the invention presents a portable litter housing that effectively contains wastes and odors and is easily accessed by a pet. The invention provides for improved elements thereof in an arrangement for the purposes described that are inexpensive, dependable and fully effective in accomplishing their intended purposes.

A clear understanding of the present invention will become readily apparent upon further review of the following specification and drawings.

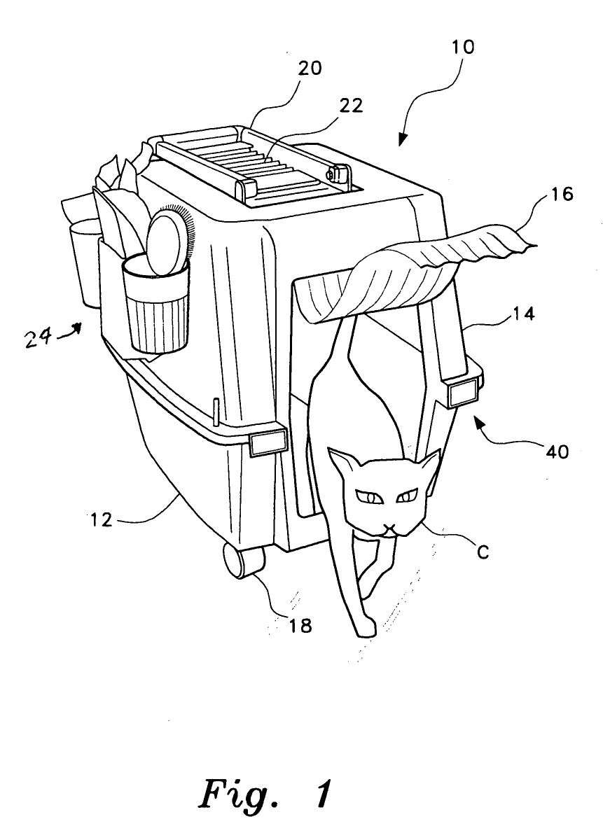

FIG. 1 is an environmental, perspective view of a wheeled litter box according to the present invention.

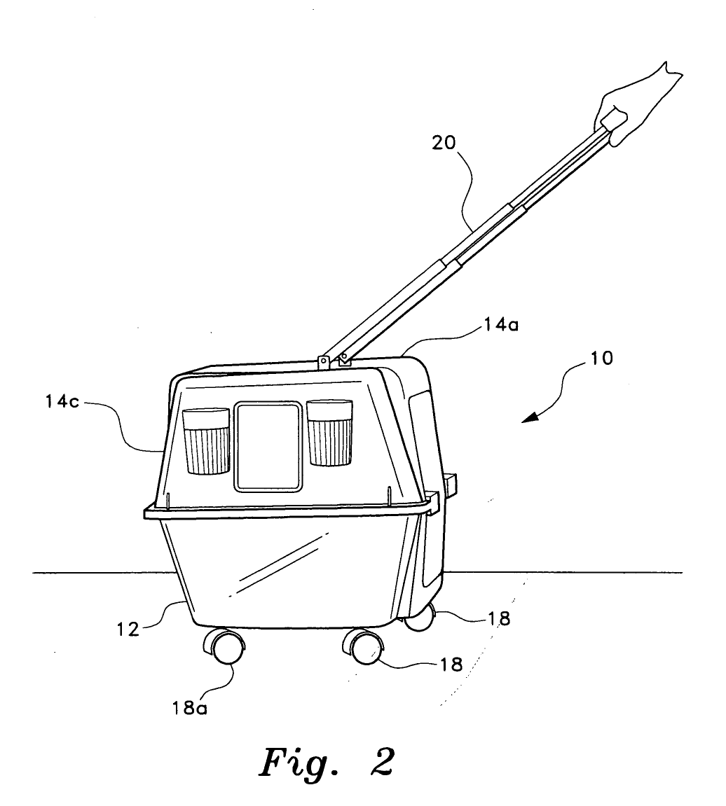

FIG. 2 is a perspective view of a wheeled litter box according to the present invention.

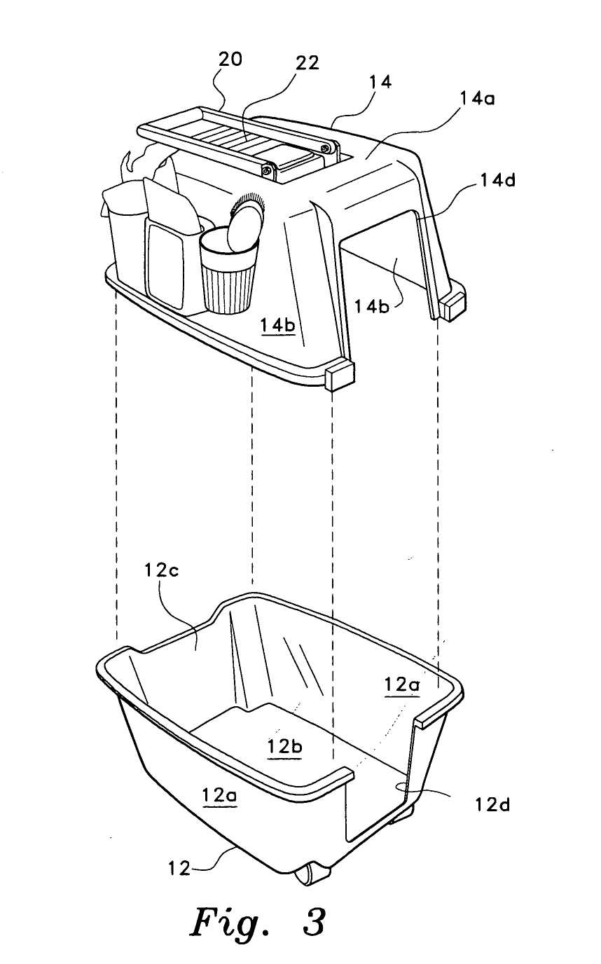

FIG. 3 is a partial, exploded view of a wheeled litter box according to the present invention.

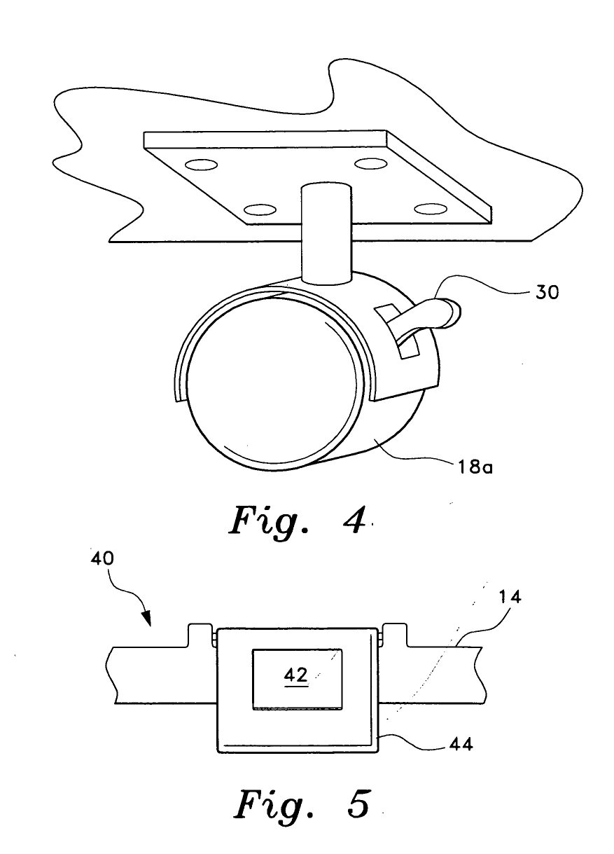

FIG. 4 is a partial view illustrating a rear wheel lock of a wheeled litter box according to the present invention.

FIG. 5 is a partial view illustrating a latch mechanism of a wheeled litter box according to the present invention.

Similar reference characters denote corresponding features consistently throughout the attached drawings.

### DETAILED DESCRIPTION OF THE PREFERRED EMBODIMENT

Attention is first directed to FIGS. 1-3 of the present invention. The wheeled litter box comprises a housing generally indicated at 10. Housing 10 consists of a lower component 12 that is removably attached to an upper component 14. Lower component 12 is configured as a tray having upstanding side walls 12a, a bottom wall 12b and an upstanding rear wall 12c. A U-shaped opening 12d is formed in the front wall for reasons as will be explained below. Upper component 14 is configured as an inverted tray having a top wall 14a, depending side walls 14b and a depending rear wall 14c. A U-shaped opening 14d is formed in the front wall. When the components are attached, openings 12d and 14d register to form a rectangular opening to allow access to the housing for a pet C. The rectangular opening is covered by a thin curtain 16, preferably fabricated from plastic material. Lower component 12 is supported on two front (18) and two rear (18a) wheels.

A padded, pivoting, telescopic handle 20 is attached to the exterior surface of top wall 14a. Telescopic handle 20 provides a convenient mechanism to roll the housing to different locations when desired. A vent 22 having a removable filter therein is disposed on top wall 14a to insure filtered air exchange for the housing so that odors are controlled. At least one depending sidewall 14b is contoured so that receptacles 24 can be snapped to the wall and retained thereon. Receptacles 24 are adapted to contain pet accessories such as brushes, disposable liners, waste removal spoons, etc. A disposable liner is disposed on the bottom wall 12b in lower component 12.

As best seen in FIG. 4, a braking device 30 is mounted on each rear wheel 18a (only one is shown). As indicated above, engagement of the braking device will prevent the pet from moving and possibly overturning the housing.

A simple, easy-to-manipulate attachment mechanism 40 (FIG. 5) includes a protruding member 42 formed on the rim of upper component 14. A latch member 44 is formed on the rim of lower component 12. Member 44 has an opening therein adapted to receive protruding member 42. An attachment mechanism is positioned at each corner of the housing. These arrangements permit a user to easily position and latch the upper and lower components together. Alternatively, the components can be quickly detached when it is desired to change the litter and clean the components.

It is to be understood that the present invention is not limited to the embodiment described above, but encompasses any and all embodiments within the scope of the following claims.

We claim:

1. A litter box, comprising:
a housing having two side walls, a rear wall, a vented top wall, a bottom wall and a front wall, said front wall having an opening therein;
a thin plastic curtain attached to said front wall and covering said opening;
a handle pivoted to said top wall;
a removable filter disposed on said top wall; and
front and rear wheels attached to said bottom wall.

2. A litter box according to claim 1, wherein said housing comprise a lower component configured as a tray and an upper component configured as an inverted tray and including plural members for attaching said lower component to said upper component.

3. A litter box according to claim 1, including braking devices disposed on said rear wheels.

4. A litter box according to claim 1, wherein said handle is a telescoping handle.

5. A litter box according to claim 1, wherein an array of receptacles is mounted to at least one of said two side walls.

6. A litter box, comprising:
a housing having two side walls, a rear wall, a vented top wall, a bottom wall and a front wall, said front wall having an opening therein;
a thin plastic curtain attached to said front wall and covering said opening;
a padded, telescoping handle pivoted to said top wall;
a removable filter disposed on said top wall;
front and rear wheels attached to said bottom wall; and
braking devices disposed on said rear wheels.

7. A litter box according to claim 6, wherein said housing comprise a lower component configured as a tray and an upper component configured as an inverted tray and including plural members for attaching said lower component to said upper component.

8. A litter box according to claim 7, wherein each of the plural members for attaching includes a protruding member and a latch member.

9. A litter box according to claim 6, wherein an array of receptacles is mounted to at least one of said two side walls.

10. A litter box, comprising:
a housing having two side walls, a rear wall, a vented top wall, a bottom wall and a front wall, said front wall having an opening therein;
a thin plastic curtain attached to said front wall and covering said opening;
a padded, telescoping handle pivoted to said top wall;
a removable filter disposed on said top wall;
front and rear wheels attached to said bottom wall;
braking devices disposed on said rear wheels; and
at least one of said side walls contoured to receive an array of receptacles removably snapped therein.

11. A litter box according to claim 10, wherein said housing comprise a lower component configured as a tray and an upper component configured as an inverted tray and including plural members for attaching said lower component to said upper component.

12. A litter box according to claim 11, wherein each of the plural members for attaching includes a protruding member formed on said upper component and a latch member formed on said lower component.
